(19) United States
(12) Patent Application Publication
(10) Pub. No.: US 2023/0069194 A1
(43) Pub. Date: Mar. 2, 2023

(54) OPTICAL DETECTION DEVICE

(71) Applicant: Peter DuHai ZUO, Fremont, CA (US)

(72) Inventor: Peter DuHai ZUO, Fremont, CA (US)

(21) Appl. No.: 17/825,052

(22) Filed: May 26, 2022

(30) Foreign Application Priority Data
Aug. 24, 2021 (CN) 202110978064.9

(51) Int. Cl. G01N 21/15; G01N 21/31; B08B 5/04; B08B 3/08; B08B 13/00

(52) U.S. Cl. CPC G01N 21/15; G01N 21/31; B08B 5/04; B08B 3/08; B08B 13/00

(57) ABSTRACT

The present disclosure relates to an optical detection device that includes a measurement mechanism and a cleaning mechanism. The measurement mechanism has a first measurement unit and a second measurement unit. One of the first and second measurement units is an optical fiber emitter end and the other one of the first and second measurement units is an optical fiber receiver end. The first and second measurement units each has a measurement end face wherein a preset gap for containing a to-be-detected sample is disposed between two of the measurement end faces and the to-be-detected sample is configured to adhere to the measurement end faces of the first and second measurement units to form a suspended fluid column The cleaning mechanism has a suction tip which is disposed close to the preset gap and is configured to suck the to-be-detected sample in the preset gap.

### TECHNICAL FIELD

The present disclosure relates to the field of optical detection, and particularly relates to an optical detection device.

### BACKGROUND

Spectrophotometry is one of commonly used biochemical test methods, which is widely used in the rapid quantitative detection of samples of sugar, nucleic acid, enzyme or protein, and the like, and the testing instrument in spectrophotometry is a spectrophotometer. The container for placing the to-be-detected sample in traditional equipment is a cuvette, but due to the relatively large internal volume of a cuvette, when a spectrophotometric detection is performed on the to-be-detected sample, a relatively large amount of consumption of the to-be-detected sample is required on the one hand, which leads to a waste of the sample of precious nucleic acid, protein and the like, and on the other hand, when performing the detection on different to-be-detected samples, repeated cleanings of the cuvette are required, and therefore a lot of extra workload is added to the experimental work.

The emergence of optical detection devices has effectively solved the aforementioned technical problem. When being used for sample detection, an optical detection device primarily utilizes the tensional traction of micro-volume liquid to form the optical path, accordingly, merely a micro volume of the to-be-detected sample is needed to acquire accurate detection data and it enables a complete replacement over the cuvette, which is of inventiveness and industrial applicability.

The Chinese Patent No. CN102207456B, as a related art, disclosed a sampling and measuring device used in micro-volume spectrophotometer, and a use method thereof. The sampling and measuring device comprises an upper measurement unit and a lower measurement unit with an adjustable distance therebetween, either a projection fiber-optics base or a reception fiber-optics base being disposed on the upper measurement unit, and correspondingly either a reception fiber-optics base or a projection fiber-optics base being disposed on the lower measurement unit, the projection fiber-optics base and the reception fiber-optics base being aligned in an up-and-down direction and having optical fibers inserted therein, a first top screw being disposed on the upper measurement unit and an up-and-down movable elevator base being disposed at a position on the lower measurement unit corresponding to that of the first top screw, and an electromagnet magnetic cylinder enclosing the elevator base and being secured to the lower measurement unit; and the sampling and measuring device further comprises a detection unit connected with the reception fiber-optics base, the detection unit comprising an optical-to-electrical conversion module, a data reception module, a detection and computation module, a value correction module, an optical path length selection module and a detection data output module. This patent literature performs a correction on the optical path length by addition of the value correction module, thereby enabling an ordinary user to implement a precise measurement without performing precise adjustment of the optical path length.

However, in the aforementioned patent literature, detection reagents on the projection fiber-optics base and the reception fiber-optics base need to be cleaned up manually every time before detection, i.e., in the traditional cleaning method, detection reagents are wiped by using a cleaning paper, which results in low cleaning efficiency.

### SUMMARY OF THE INVENTION

The present disclosure provides an optical detection device to at least solve the low-cleaning-efficiency issue of optical detection devices in the conventional art.

Technical solutions provided in the present disclosure are as follows.

Provided is an optical detection device that comprises a measurement mechanism and a cleaning mechanism. The measurement mechanism has a first measurement unit and a second measurement unit. One of the first and second measurement units is an optical fiber emitter end and the other one of the first and second measurement units is an optical fiber receiver end. The first and second measurement units each has a measurement end face wherein a preset gap for containing a to-be-detected sample is disposed between two of the measurement end faces and the to-be-detected sample is configured to adhere to the measurement end faces of the first and second measurement units to form a suspended fluid column. The cleaning mechanism has a suction tip which is disposed close to the preset gap and is configured to suck the to-be-detected sample in the preset gap.

Optionally, the first and second measurement units may be disposed horizontally.

Optionally, the first and second measurement units may each have a measurement end face that is configured to form the preset gap. The measurement end face may include a flow-guiding surface and an adsorption surface. The flow-guiding surface may be formed to surround the adsorption surface to allow the to-be-detected sample to pass over the flow-guiding surface and then to flow to the adsorption surface so as to adhere to the adsorption surface.

Optionally, the flow-guiding surface may be a chamfered structure and the adsorption surface may be a planar structure.

Optionally, the cleaning mechanism may further include a first control unit and a suction assembly. The control unit may be connected with the suction assembly and the suction assembly may be connected with the suction tip. The control unit may be configured to control the suction assembly to suck the to-be-detected sample via the suction tip.

Optionally, the optical detection device may further include a mounting assembly that has a mounting chassis whereon the first and second measurement units are both disposed.

Optionally, a container tub may be disposed in the mounting chassis. The two of the measurement end faces may be both disposed inside the container tub. After an injection of cleansing liquid into the container tub, the two of the measurement end faces may be completely immersed in the cleansing liquid.

Optionally, after the injection of cleansing liquid into the container tub, the cleansing liquid may be configured to adhere to an entirety of side walls of the container tub and be situated up to a rim of a tub opening of the container tub.

Optionally, the cleaning mechanism may further include a fluid injection unit having a fluid injection head. The fluid injection head may be able to be disposed close to the preset gap and configured to inject the cleansing liquid into the container tub.

Optionally, the optical detection device may further include a driving assembly that has a cover plate whereon the fluid injection head is disposed. The driving assembly may be configured to drive the fluid injection head, via the cover plate, to move towards or away from the preset gap.

Optionally, the cleaning mechanism further comprises a fluid injection opening that is opened on an interior surface of the side wall of the container tub and is configured to inject the cleansing fluid into the container tub.

Technical solutions in the present disclosure provide at least the following advantages.

i) An optical detection device according to the present disclosure comprises a measurement mechanism and a cleaning mechanism. The measurement mechanism has a first measurement unit and a second measurement unit. One of the first and second measurement units is an optical fiber emitter end and the other one of the first and second measurement units is an optical fiber receiver end. The first and second measurement units each has a measurement end face wherein a preset gap for containing a to-be-detected sample is disposed between two of the measurement end faces and the to-be-detected sample is configured to adhere to the measurement end faces of the first and second measurement units to form a suspended fluid column The cleaning mechanism has a suction tip which is disposed close to the preset gap and is configured to suck the to-be-detected sample in the preset gap.

When using the optical detection device, the to-be-detected sample is injected into the preset gap so as to adhere to the measurement end faces of the first and second measurement units to form a stable suspended fluid column, and then the absorbance of the to-be-detected sample is measured by the measurement mechanism. The cleaning mechanism is started after the measurement is completed, and the to-be-detected sample in the preset gap is thereby sucked out and removed rapidly under a negative-pressure suction effect applied by the suction tip of the cleaning mechanism. Compared to the conventional way of wiping manually using a cleaning paper, in the optical detection device according to the present disclosure, the cleaning process is completed automatically, the cleaning efficiency is vastly increased, and the cleaning effect is better, thereby allowing more precise detection.

ii) An optical detection device according to the present disclosure can further include a mounting assembly that has a mounting chassis whereon the first and second measurement units are both disposed. A container tub is disposed in the mounting chassis. The two of the measurement end faces are both disposed inside the container tub. After an injection of cleansing liquid into the container tub, the two of the measurement end faces are configured to be completely immersed in the cleansing liquid.

The mounting chassis is a single component, and the first measurement unit, the second measurement unit and the suction tip can be mounted on the mounting chassis, thereby providing structural compactness and convenience in mounting. Further, a container tub is disposed in the mounting chassis, at least for the purposes as follows:

Firstly, it is for providing space for performing a measurement—i.e., the measurement end faces of the first and second measurement units extend into the container tub and then form a preset gap for containing a to-be-detected sample.

Secondly, it is for containing cleansing liquid—i.e., the to-be-detected sample in the preset gap is dissolved by the cleansing liquid and then sucked out by the suction tip, thereby the cleaning effect is increased. Meanwhile, by using the suction force of the cleaning mechanism, the cleansing liquid can be removed thoroughly, thereby preventing newly-added to-be-detected sample, when it is in contact with the detection platform, from being diluted by the residual cleansing liquid and resulting in error in the detected data.

iii) In an optical detection device according to the present disclosure, optionally, the first and second measurement units may be disposed horizontally, that is, each of the two end faces of the first and second measurement units is vertically disposed and respectively situated left and right, thereby enabling injection of fluid sample from above into the optical detection device without removal of any one of the first and second measurement units in advance of the injection of fluid sample. Accordingly, the operational process of fluid sample injection is significantly simplified (in comparison, it is found in virtually all the similar devices in the conventional art that the two measurement end faces thereof are arranged above and below in a vertical direction, and since the lateral injection of fluid sample is unavailable, the upper measurement end face must be removed in advance every time a fluid sample is injected, which results in complexity of the operational process). In addition, it can be better ensured that the injected fluid sample stably forms a suspended fluid column between the measurement end faces of the first and second measurement units without coming into contact with any other wall of the optical detection device.

iv) In an optical detection device according to the present disclosure, the measurement end face can include a flow-guiding surface and an adsorption surface. The flow-guiding surface can be formed to surround the adsorption surface to allow the to-be-detected sample to pass over the flow-guiding surface and then to flow to the adsorption surface.

After being injected into the preset gap, the to-be-detected sample flows along the flow-guiding surface to the adsorption surface. There exists adhesion force between the adsorption surface and the to-be-detected sample, which allows the to-be-detected sample to counteract the downward force of gravity of itself so as to adhere to the adsorption surface, so that a suspended fluid column is formed between the adsorption surfaces of the first and second measurement units. And then detection is performed by the first and second measurement units.

v) In an optical detection device according to a certain aspect of the present disclosure, a fluid injection opening configured to inject the cleansing liquid is opened on an interior surface of the side wall of the container tub. Accordingly, compared to the conventional way that supplies cleansing liquid from above into the optical detection device, a movement mechanism that is disposed above the optical detection device and used for supplying cleansing liquid can be dispensed with, thereby simplifying the structure of the optical detection device.

### BRIEF DESCRIPTION OF THE DRAWINGS

For more clearly illustrating the technical solutions in detailed embodiments of the present disclosure or in the conventional art, the accompanying drawings, which are needed for describing the detailed embodiments or the conventional art, will be briefly introduced hereinafter. Apparently, the accompanying drawings described below refer to some embodiments of the present application, and other drawings can be acquired on the basis of the accompanying drawings illustrated herein, by those skilled in the art without making any creative effort.

FIG. 1 is a perspective view of an optical detection device according to some embodiments of the present application.

FIG. 2 is a partially enlarged view of a top view of an optical detection device according to some embodiments of the present application.

FIG. 3a is a schematic diagram of an optical detection device according to some embodiments of the present disclosure in initial state.

FIG. 3b is a schematic diagram of an optical detection device according to some embodiments of the present disclosure when the preset gap thereof has been injected with a to-be-detected sample.

FIG. 3c is a schematic diagram of an optical detection device according to some embodiments of the present disclosure when the container tub 7 thereof has been injected with cleansing liquid.

FIG. 4 is a schematic diagram of a top view of an optical detection device according to a certain embodiment of the present disclosure.

FIG. 5 is a schematic diagram of the structure shown in FIG. 4 without a cover plate.

FIG. 6 is a schematic diagram of a partially enlarged view of the structure shown in FIG. 5.

FIG. 7 is a schematic structural diagram of the mounting chassis shown in FIG. 6.

FIG. 8 is a perspective view of an optical detection device according to another certain embodiment of the present disclosure.

FIG. 8a is a vertical sectional view of the optical detection device according to the embodiment of FIG. 8.

FIG. 8b is a partially enlarged view of a vertical sectional view of the optical detection device according to the embodiment of FIG. 8.

### DESCRIPTION OF REFERENCE NUMERALS

L: light source, F: optical fiber,
G: preset gap, P: fluid passage,
1: first measurement unit, 2: second measurement unit,
3: suction tip, 4: detector, 5: mounting chassis,
6: suction hole, 7: container tub, 71: tub opening, 8: fluid injection head,
9: cover plate, 10: measurement end face,
11: flow-guiding surface, 12: adsorption surface,
13: geared motor, 14: to-be-detected sample,
15: negative pressure pump, 16: optical fiber emitter end,
17: optical fiber receiver end, 18: cleansing liquid,
I: fluid injection opening, and C: fluid supply path.

### DETAILED DESCRIPTION OF EMBODIMENTS

A description of technical solutions of the present disclosure will be presented in a clear and complete fashion hereinafter by reference to the accompanying drawings. Apparently, the embodiments described herein are not all but some of the embodiments of the present application. Any other embodiment that can be acquired, on the basis of the embodiments described in the present disclosure, by those skilled in the art without making any creative effort, shall be encompassed within the scope of protection of the present application.

In the description of the present application, it should be noted that, directions or positional relationships indicated by the terms “center”, “upper”, “lower”, “left”, “right”, “vertical”, “horizontal”, “inside”, “outside” and the like are based on the directions or positional relationships illustrated in the accompanying drawings, which are merely for the purpose of facilitating the description of the present disclosure and simplifying the description and are not indicative or suggestive of the corresponding device or element necessarily being in or being constructed/operated in a specific orientation, and thus these terms are not to be understood as a limitation on the present disclosure. In addition, the terms “first”, “second”, “third” and the like are used for descriptive purposes only and are not to be understood as being indicative or suggestive of relative importance.

In the description of the present disclosure, it should be noted that, unless otherwise specified or limited, the terms “installed”, “connected”, “coupled” or the like should be broadly understood, for instance, it may be a fixed connection, a detachable connection or an integral connection, may be a mechanical connection or an electrical connection, may be a direct connection or an indirect connection via an intermediate medium, or otherwise may be an interior communication between two elements. For those skilled in the art, specific meanings of the above terms in the present disclosure can be understood according to the specific circumstances thereof.

Moreover, technical features involved in different embodiments of the present disclosure described hereinafter can be combined with one another, unless mutually contradicted.

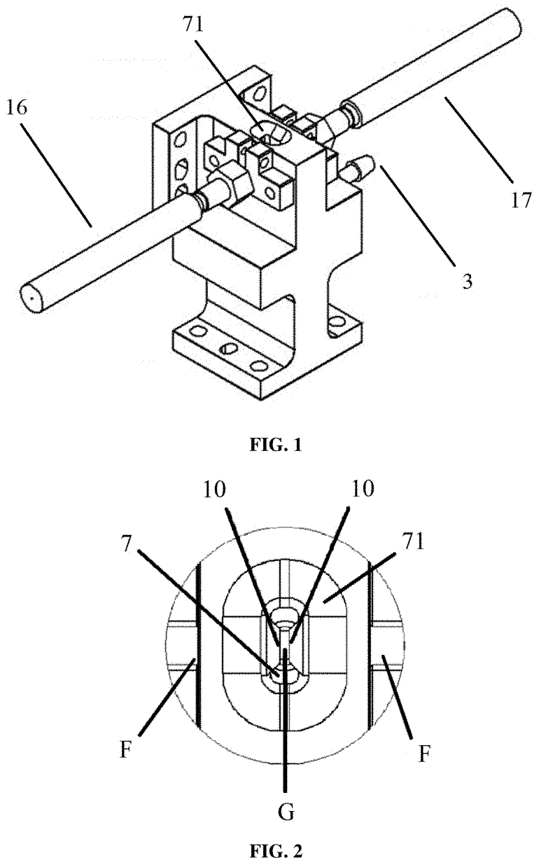

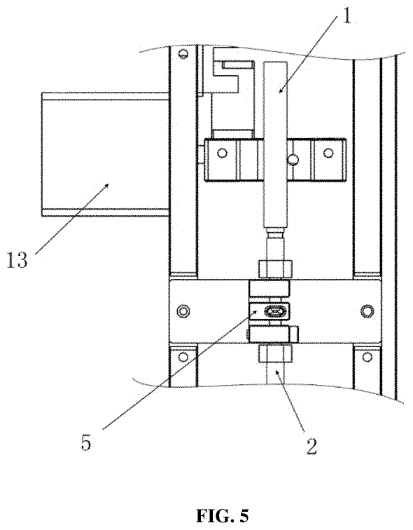

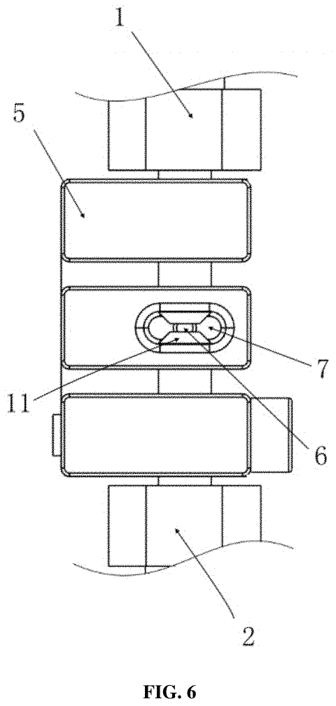

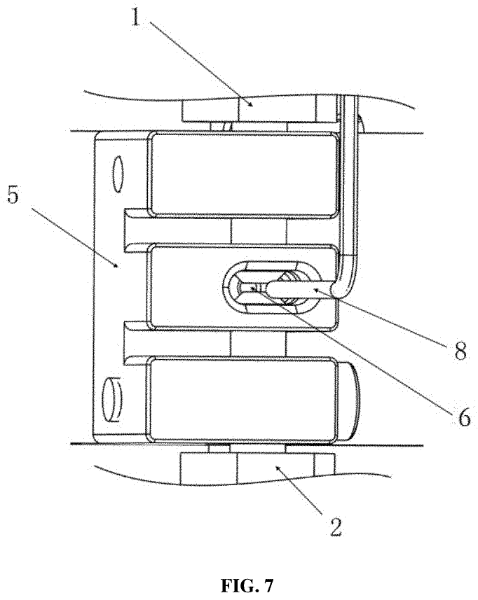

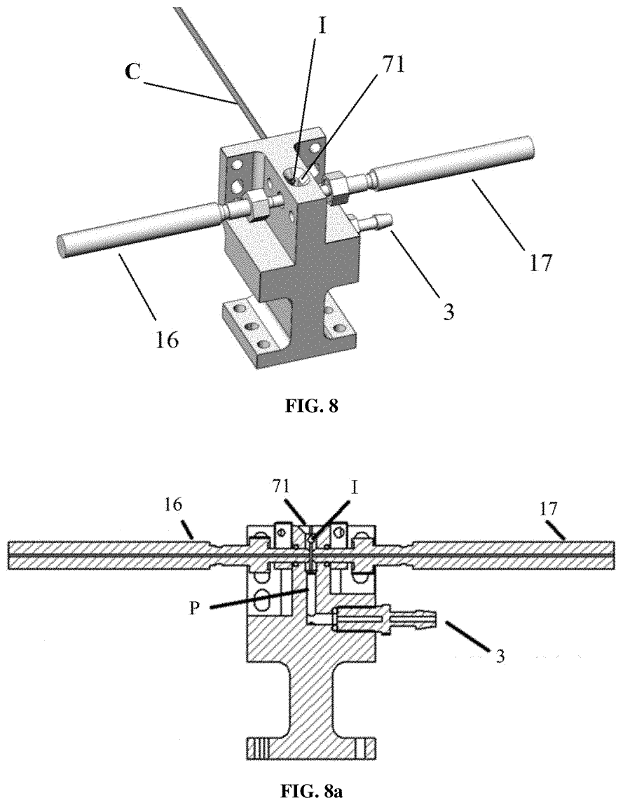

As shown in FIGS. 1 to 8b, any one of the optical detection devices according to some embodiments of the present disclosure comprise a measurement mechanism and a cleaning mechanism. The measurement mechanism has a first measurement unit 1 and a second measurement unit 2. One of the first and second measurement units 1, 2 may be an optical fiber emitter end and the other one of the first and second measurement units may be an optical fiber receiver end. The first and second measurement units 1, 2 each has a measurement end face 10 wherein a preset gap G for containing a to-be-detected sample 14 is disposed between two of the measurement end faces 10 and the to-be-detected sample 14 adheres to the measurement end faces 10 of the first and second measurement units 1, 2 to form a suspended fluid column. The cleaning mechanism has a suction tip 3 which is disposed close to the preset gap G and is configured to suck the to-be-detected sample 14 in the preset gap G. It should be noted that, in the present embodiment, a conventional tool is adopted to inject the to-be-detected sample 14 into the preset gap G, thus no further description thereof is given herein. The preset gap herein can be set up on the basis of the actual situations of detection, and the size thereof is not specified herein. Fluid of the fluid column may be liquid, emulsion and the like, however, is not limited thereto. Specifically, an optical detection device according to the present disclosure may be an optical detection device, i.e. a micro-volume spectrophotometer, that is used for measurement of light absorption characteristics of fluid samples.

Further, the cleaning mechanism may further include a first control unit and a suction assembly. The control unit may be connected with the suction assembly. The suction assembly may be connected with an outlet end of the suction tip 3, a fluid passage P may be connected with an inlet end of the suction tip 3, and the fluid passage P may extend to the container tub 7. The control unit may be configured to control the suction assembly to suck the to-be-detected sample 14 via the suction tip 3. In the present embodiments, the suction assembly may include a negative pressure pump 15. The negative pressure pump 15 may be connected with the suction tip 3.

Here, the measurement mechanism may further include a second control unit and may control the operation of the first and second measurement units 1, 2 via the second control unit. As an alternative embodiment, functionalities performed by the first and second control units may be implemented by a single control unit.

In the present embodiments, referring to FIGS. 1 to 3c, the first and second measurement units 1, 2 may be disposed horizontally, i.e., one of the measurement end faces 10 of the first and second measurement units 1, 2 may be disposed on the right side and the other one of the measurement end faces 10 of the first and second measurement units 1, 2 may be disposed on the left side, that is, each of the two end faces 10 of the first and second measurement units 1, 2 is vertically disposed and respectively situated left and right, thereby enabling injection of fluid sample from above into the optical detection device without removal of any one of the first and second measurement units 1, 2 in advance of the injection of fluid sample.

Accordingly, the operational process of fluid sample injection is significantly simplified (in comparison, it is found in virtually all the similar devices in the conventional art that the two measurement end faces are arranged above and below in vertical direction. Since the lateral injection of fluid sample is unavailable, the upper measurement end face must be removed in advance every time a fluid sample is injected, which results in complexity of the operational process). In addition, it can be better ensured that the injected fluid sample stably forms a suspended fluid column between the measurement end faces 10 of the first and second measurement units 1, 2, without coming into contact with any other wall of the optical detection device.

Here, the first and second measurement units 1, 2 may each have a measurement end face 10 that is configured to form the preset gap. The measurement end face 10 includes a flow-guiding surface 11 and an adsorption surface 12. The flow-guiding surface 11 may be formed to surround the adsorption surface 12 to allow a to-be-detected sample 14 to pass over the flow-guiding surface 11 and then to flow to the adsorption surface 12.

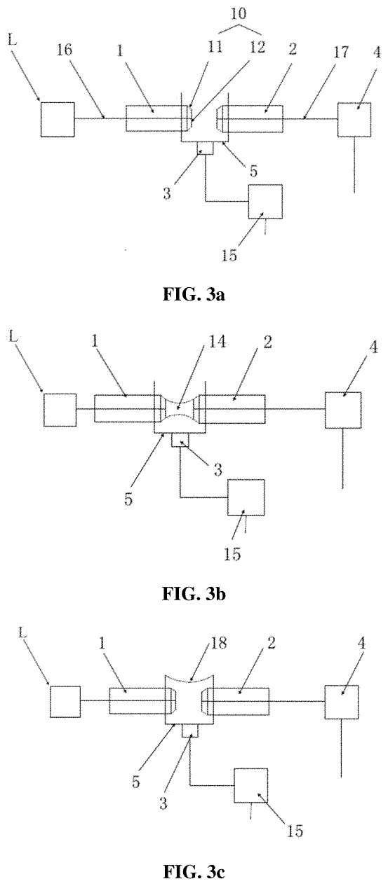

As shown in FIGS. 2, 3a, and 6, specifically, the flow-guiding surface 11 may be a chamfered structure and the adsorption surface 12 may be a planar structure. Here, the structure of the flow-guiding surface 11 may be adjusted to actual needs, i.e., may be specified as a rounded surface, a quincunx, or the like, as long as the flow-guiding surface 11 is able to guide the to-be-detected sample 14 onto the adsorption surface 12. Specifying the flow-guiding surface allows the to-be-detected sample 14 to stably adhere to the adsorption surface 12, thereby facilitating the formation of a stable suspended fluid column.

After being injected into the preset gap, the to-be-detected sample 14 may flow along the flow-guiding surface 11 to the adsorption surface 12. There may exist adhesion force between the adsorption surface 12 and the to-be-detected sample 14, which allows the to-be-detected sample 14 to counteract the downward force of gravity of itself so as to adhere to the adsorption surface 12, so that a suspended fluid column is formed between the adsorption surfaces 12 of the first and second measurement units 1, 2. And then detection may be performed by the first and second measurement units 1, 2. In this case, a horizontal propagation optical path can be formed within the fluid column, as can be seen in the preset gap G shown in FIG. 2.

As an alternative embodiment, the first and second measurement units 1, 2 may be disposed at any angle, which just needs to allow the to-be-detected sample 14 to adhere to the measurement end faces 10 thereof and form a stable suspended fluid column between the two measurement end faces 10. For instance, the first and second measurement units 1, 2 may be disposed at a tilt angle of 45 degrees, in vertical direction, or the like. When disposed in vertical direction, the measurement end faces 10 of the first and second measurement units 1, 2 may be disposed in an upper position and a lower position, respectively.

Further, the optical detection device may further include a mounting assembly. The mounting assembly may have a mounting chassis 5 whereon the first measurement unit 1, the second measurement unit 2 and the suction tip 3 may all be disposed. The mounting chassis 5 may be a single component for mounting the first measurement unit 1, the second measurement unit 2 and the suction tip 3 thereon, allowing the entire apparatus to be of structural compactness and convenience in mounting/demounting.

A container tub 7 may be disposed in the mounting chassis 5. The mounting chassis 5 may have two mounting holes communicated with the container tub 7. The two mounting holes may be disposed to face each other and sealedly connected respectively with the first and second measurement units 1, 2. The measurement end faces 10 thereof may be both disposed inside the container tub 7.

The purpose of providing the container tub 7 herein is at least as follows:

Firstly, it is for providing space for performing a measurement—i.e., the measurement end faces 10 of the first and second measurement units 1, 2 extend into the container tub 7 and then form a preset gap G for containing a to-be-detected sample 14.

Secondly, it is for containing cleansing liquid 18—i.e., the to-be-detected sample in the preset gap G is dissolved by the cleansing liquid 18 and then sucked out by the suction tip 3, thereby the cleaning effect is increased. Meanwhile, by using the suction force of the cleaning mechanism, the cleansing liquid 18 can be removed thoroughly, thereby preventing newly-added to-be-detected sample 14, when it is in contact with the detection platform, from being diluted by the residual cleansing liquid 18 and resulting in error in the detected data.

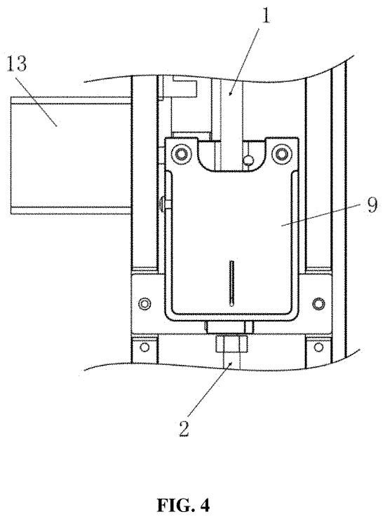

The cleansing liquid 18 may be injected until the two measurement end faces 10 are completely immersed in the cleansing liquid 18. The cleansing liquid 18 may be configured to adhere to the entirety of side walls of the container tub 7. The injection may be terminated when the cleansing liquid 18 becomes situated up to a rim of a tub opening 71 of the container tub 7, and the cleansing liquid 18 should not flow over the tub opening 71 of the container tub 7, i.e., the best status is as illustrated in FIG. 3, that is, the surface of the cleansing liquid 18 forms a downward-concave curved shape. Such configuration is based on the considerations as follows:

Firstly, it is to guarantee that the to-be-detected sample 14 is completely immersed in the cleansing liquid 18, thereby increasing the cleaning effect. Secondly, it is to clean side walls of the container tub 7. Because the injection of the to-be-detected sample 14 may not be perfectly aimed at the preset gap, the side walls of the container tub 7 may be contaminated by the to-be-detected sample 14. Therefore, after the cleansing liquid 18 adheres to the entirety of the side walls of the container tub 7, the to-be-detected sample 14 remained on the side walls of the container tub 7 may be thoroughly removed so as to prevent any influence on subsequent detection.

Specifically, the suction tip 3 may be disposed at the bottom of the container tub 7, and all the edges of the mounted tub may form an arc-shaped transition, thereby facilitating thorough removal of the fluid within the container tub 7. As a preferred embodiment, the bottom of the container tub 7 may be specified as an inverted-cone-shaped structure. As an alternative embodiment, the suction tip 3 may be disposed on a side wall of the container tub 7 as well.

Further, in an optical detection device according to a certain embodiment of the present disclosure, the cleaning mechanism may further include a fluid injection unit. The fluid injection unit may have a fluid injection head 8 and a fluid injection pump communicated with the fluid injection head 8. The fluid injection head 8 may be able to be disposed close to the preset gap G. The fluid injection pump may inject the cleansing liquid 18 into the container tub 7 via the fluid injection head 8.

As an alternative embodiment, the fluid injection unit may be not provided herein, and the cleansing liquid 18 may be injected manually by using an injection needle.

The optical detection device may further include a driving assembly that has a cover plate 9 whereon the fluid injection head 8 is disposed. The driving assembly may be configured to drive the fluid injection head 8, via the cover plate 9, to move towards or away from the preset gap G. Specifically, when the cleansing liquid 18 needs to be injected, the fluid injection head 8 may be driven by the cover plate 9 to move towards the preset gap G, or otherwise when the to-be-detected sample 14 needs to be injected, the fluid injection head 8 may be driven by the cover plate 9 to move away from the preset gap G. Here, the cover plate 9 can play the role of mounting and positioning the fluid injection head 8, thereby allowing a more precise injection of fluid.

As one embodiment of the driving assembly, the movement of the fluid injection head 8 towards or away from the preset gap G may be implemented by turn-over of the cover plate 9. The purpose of driving, by the cover plate, the fluid injection head 9 to move away from the preset gap G is to provide space for performing an injection of the to-be-detected sample to prevent interference in the injection of the to-be-detected sample. The detailed embodiment may be as follows. The driving assembly may include a geared motor 13. An output shaft of the geared motor 13 may be connected with an end of the cover plate 9 and may be configured to drive the cover plate 9 to turn over, thereby implementing the movement of the fluid injection head 8 towards or away from the preset gap G.

As another embodiment of the driving assembly, the movement of the fluid injection head 8 towards or away from the preset gap G may be implemented by a translational movement of the cover plate 9. The detailed embodiment may be as follows:

The driving assembly may include a geared motor 13 and a rack. The rack may be connected with the cover plate 9 and engaged by an output shaft of the geared motor 13 so as to drive the cover plate 9 to move as the output shaft rotates, thereby implementing the movement of the fluid injection head 8 towards or away from the preset gap G.

The operation of any one of the optical detection devices according to the present embodiments is shown in FIGS. 3a to 3c. When using the optical detection device, the to-be-detected sample 14 may be placed into the preset gap G, a light beam may be emitted from an optical fiber emitter end 16 of the first measurement unit 1 and received by an optical fiber receiver end 17 of the second measurement unit 2, wherein the optical fiber emitter end 16 is connected to a light source L, a detection may be performed on the received light beam by a detector 4 connected with the second measurement unit 2, then the absorbance of the to-be-detected sample 14 may be computed, and then a qualitative and quantitative analysis may be performed on the to-be-detected sample 14.

After the measurement is completed, the cover plate 9 may be driven, by the driving assembly, to operate to cause the fluid injection head 8 to move toward the preset gap G. The cleansing liquid 18 may be injected into the container tub 7 by the fluid injection head 8 of the fluid injection unit. After completion of the injection, the fluid injection head 8 may be driven to move away from the preset gap G, and the to-be-detected sample 14 may be dissolved by the cleansing liquid 18, then the negative pressure pump 15 may be started and rapidly suck out the to-be-detected sample 14 in the container tub 7 via the suction tip 3. After completion of the cleaning, the next detection may be performed. In the optical detection device, the cleaning process can be completed automatically. The cleaning efficiency is vastly increased, and the cleaning effect is better, thereby allowing more precise detection.

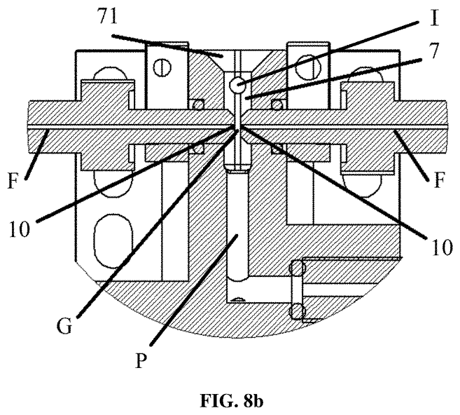

In the optical detection device according to another embodiment of the present disclosure, the cleaning mechanism may further include a fluid injection unit. The fluid injection unit may include a fluid injection opening I. As shown in FIGS. 8, 8a, and 8b, the fluid injection opening I is opened on an interior surface of the side wall of the container tub 7 and a fluid supply path C communicated with the fluid injection opening I is extended out from one side of the optical detection device. The fluid supply path C may be connected with a fluid injection pump and inject cleansing liquid into the container tub 7 by means of the fluid injection pump. Accordingly, compared to the embodiment that supplies cleansing liquid from above into the optical detection device, a movement mechanism that is disposed above the optical detection device and used for supplying cleansing liquid can be dispensed with, thereby simplifying the structure of the optical detection device. As an alternative embodiment, the fluid supply path C may be extended out from below the optical detection device, however, is not limited thereto.

Apparently, the above-described embodiments are merely exemplary for the purpose of clear illustration rather than restrictive as regards embodiments. Other various changes and modifications can be implemented by those skilled in the art on the basis of the above-described illustrations. It is not necessary or possible to exhaustively list all the embodiments. However, any change or modification that is obviously derived therefrom is otherwise encompassed within the protective scope of the present disclosure.

What is claimed is:

1. An optical detection device, comprising:
a measurement mechanism having a first measurement unit (1) and a second measurement unit (2), one of the first and second measurement units being an optical fiber emitter and the other of the first and second measurement units being an optical fiber receiver, and the first and second measurement units each having a measurement end face (10) wherein a preset gap for containing a to-be-detected sample is disposed between two of the measurement end faces (10) and the to-be-detected sample (14) is configured to adhere to the measurement end faces (10) of the first and second measurement units to form a suspended fluid column; and
a cleaning mechanism having a suction tip (3) which is disposed close to the preset gap and is configured to suck the to-be-detected sample (14) in the preset gap.

2. The optical detection device according to claim 1, wherein the first and second measurement units are disposed horizontally.

3. The optical detection device according to claim 2, wherein the measurement end face (10) comprises a flow-guiding surface (11) and an adsorption surface (12), the flow-guiding surface (11) is formed to surround the adsorption surface (12) to allow a to-be-detected sample (14) to pass over the flow-guiding surface (11) and then flow to the adsorption surface (12) so as to adhere to the adsorption surface (12).

4. The optical detection device according to claim 3, wherein the flow-guiding surface (11) is a chamfered structure and the adsorption surface (12) is a planar structure.

5. The optical detection device according to claim 1, wherein the cleaning mechanism further comprises a first control unit and a suction assembly, the control unit being connected with the suction assembly, the suction assembly being connected with the suction tip (3), and the control unit being configured to control the suction assembly to suck the to-be-detected sample (14) via the suction tip (3).

6. The optical detection device according to claim 1, further comprising a mounting assembly having a mounting chassis (5) whereon the first and second measurement units are both disposed.

7. The optical detection device according to claim 6, wherein:
a container tub (7) is disposed in the mounting chassis (5);
the two of the measurement end faces (10) are both disposed inside the container tub (7); and
after an injection of cleansing liquid (18) into the container tub (7), the two of the measurement end faces (10) are configured to be completely immersed in the cleansing liquid (18).

8. The optical detection device according to claim 7, wherein after the injection of cleansing liquid (18) into the container tub (7), the cleansing liquid (18) is configured to adhere to an entirety of side walls of the container tub (7) and be situated up to a rim of a tub opening (71) of the container tub (7).

9. The optical detection device according to claim 7, wherein the cleaning mechanism further comprises a fluid injection unit having a fluid injection head (8), the fluid injection head (8) being able to be disposed close to the preset gap and configured to inject the cleansing liquid (18) into the container tub (7).

10. The optical detection device according to claim 9, further comprising a driving assembly having a cover plate (9) whereon the fluid injection head (8) is disposed, the driving assembly being configured to drive the fluid injection head (8), via the cover plate (9), to move towards or away from the preset gap.

11. The optical detection device according to claim 8, wherein the cleaning mechanism further comprises a fluid injection opening (I) being opened on an interior surface of the side wall of the container tub (7) and being configured to inject the cleansing liquid (18) into the container tub (7).
